(19) United States
(12) Patent Application Publication
(10) Pub. No.: US 2025/0139456 A1
(43) Pub. Date: May 1, 2025

(54) SYSTEMS AND METHODS FOR MINIMIZING DEVELOPMENT TIME IN ARTIFICIAL INTELLIGENCE MODELS BASED ON DATASET FITTINGS

(71) Applicant: Capital One Services, LLC, McLean, VA (US)

(72) Inventor: Michael LANGFORD, Plano, TX (US)

(73) Assignee: Capital One Services, LLC, McLean, VA (US)

(21) Appl. No.: 18/498,540

(22) Filed: Oct. 31, 2023

(51) Int. Cl. G06N 3/0985; G06F 17/14; G06N 3/047

(52) U.S. Cl. CPC G06N 3/0985; G06F 17/142; G06N 3/047

(57) ABSTRACT

Methods and systems are described herein for minimizing development time in artificial intelligence models by automating model selection based on dataset fittings of time-series data prior to hyperparameter optimization. The system may select a statistical profile type to identify in a first dataset. The system may retrieve a statistical model corresponding to the statistical profile type. The system may select, based on a first statistical profile, a first untrained model from a first plurality of untrained models for training, wherein the first plurality of untrained models comprises respective algorithms for time-series forecasting and wherein each of the first plurality of untrained models comprises default hyperparameter tuning. The system may, based on selecting the first untrained model, tune a first hyperparameter of the first untrained model using the first dataset.

### BACKGROUND

In recent years, the use of artificial intelligence, including, but not limited to, machine learning, deep learning, etc. (referred to collectively herein as “artificial intelligence models,” “machine learning models,” or simply “models”) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high quality can be complex and time consuming. Additionally, data that is obtained may need to be categorized and labeled accurately, which can be difficult, time consuming, and a manual task.

Second, artificial intelligence models, particularly models trained on time-series data, require extensive hyperparameter tuning, which itself requires specialized knowledge to design, program, and/or perform the tuning, which can limit the amount of people and resources available to create practical implementations of artificial intelligence models. Hyperparameter tuning is the process of selecting the optimal values for hyperparameters in a model. Hyperparameters are parameters that are set before the learning process begins and control various aspects of the training process. They are not learned from the data but are determined by the user or data scientist based on domain knowledge, experimentation, and heuristics. Hyperparameter tuning is important because the performance of a model is highly dependent on the values of these hyperparameters. Poorly chosen hyperparameters can lead to suboptimal model performance, including overfitting or underfitting. The goal of hyperparameter tuning is to find the set of hyperparameters that result in the best possible performance on the validation or test dataset.

These technical problems may present an inherent problem with attempting to use artificial intelligence-based solutions for applications involving time-series data.

### SUMMARY

Systems and methods are described herein for novel uses and/or improvements to artificial intelligence applications, particularly in the context of hyperparameter tuning. As one example, systems and methods are described herein for minimizing development time in artificial intelligence models by automating model selection based on dataset fittings of time-series data prior to hyperparameter optimization. As another example, the systems and methods may minimize hyperparameter optimization based on dataset fittings. As yet another example, the systems and methods describe novel uses and/or improvements to the detection of data trends for data fittings.

In existing model development lifecycles, choosing the best model to fit a given dataset and optimizing its hyperparameters is an incredibly time-consuming and tedious process. This is particularly true for time-series data. For example, in time-series forecasting, some models will be better suited to fit a given dataset of certain attributes, such as the seasonal periods, presence of trends, and/or smoothness of the data. As such, certain time-series forecasting models may not be effective if there is no seasonality present in the data, whereas other time-series forecasting models may be very effective if the dataset is stationary. Currently, the method of determining this is to train, fit, and/or tune a plurality of statistical routines and then validate the results from each model. However, this results in redundant training, fitting, and/or tuning time.

Accordingly, systems and methods described herein aim to reduce the redundancies and improve the efficiencies of model selection, model training, and/or hyperparameter selection. The systems and methods achieve this by using information about the attributes of the time-series dataset that may be used to determine a model that may be most effective at fitting a given dataset. If a model is selected prior to hyperparameter optimization, the time and resources spent training, fitting, and/or tuning models that are not selected can be avoided.

However, determining to select a model prior to hyperparameter optimization and validation raises numerous technical challenges. First, the attributes of the time-series dataset, if known, do not necessarily have a linear relationship with the effectiveness of any given model on any given dataset. For example, datasets may have conflicting (or complimentary) attributes that weigh on the effectiveness of a given model, which may not be known until after extensive training and validation. Additionally, some attributes (e.g., whether data is “spiky”) do not have a known determination technique.

As such, the systems and methods gather information about a time-series profile of a given dataset using a plurality of statistical tests to determine details such as stationarity, seasonality, and/or presence of trends. The systems and methods may overcome the technical challenge of a lack of linear relationships between attributes and model effectiveness through the use of an aggregate statistical profile based on the results of a plurality of known statistical analyses. The use of the results of the plurality of known statistical analyses provides a basis for determining potential attributes and correlations between them that may affect the effectiveness of any given model.

To overcome a second technical challenge (i.e., the lack of a known standard for determining correlations between attributes that may affect the effectiveness of any given model), the system applies a profiling model to the aggregate statistical profile. For example, the system may apply a profiling model on the aggregate statistical profile using a scoring policy or a time-series embedding of the dataset combined with the aggregate statistical profile. In either case, the profiling model may be trained on the scoring policy and/or a time-series embedding of the dataset combined with the aggregate statistical profile to determine a likelihood of the effectiveness of a given model on the given dataset and/or likely hyperparameters for the given model.

For example, the systems and methods may determine an aggregate statistical profile based on the results of each of the statistical tests. The systems and methods may then determine a likely model, or likely hyperparameters for a given model, by applying a profile model (e.g., based on a scoring policy or embedding) for each model. The systems and methods may then use the results to determine how a given time-series model may be affected (e.g., whether it is benefited, harmed, and/or disqualified entirely) by the attributes present in the dataset.

The systems and methods may then filter, prioritize, and/or select models based on the attributes. For example, the system may disqualify a model and thus prevent further time and/or resources related to testing and/or training the model. In contrast, models that are not disqualified may be further scored to allow for non-binary classification and/or analysis to account for the conflicting (or complimentary) attributes that weigh on the effectiveness of a given model. Once all remaining models are scored, the system may select the top-scored models to be fit and tuned, and the model with the best validation score may be selected for use by a user. By doing so, the system automates the profiling of the time-series dataset (which gathers information about what makes this dataset unique) and automatically selects and fits the best-suited models to the specific time-series profile. As such, the system saves countless hours for any user who wishes to apply time-series forecasting techniques to a given dataset and allows for the democratization of artificial intelligence by reducing the barrier to entry for many users to start forecasting.

To overcome a third technical challenge (i.e., the lack of a known standard for determining attributes such as “spiky” data), the system may further use a novel statistical analysis and use the results thereof for populating the aggregate statistical profile. For example, through the use of customized statistical analyses (e.g., based on the dataset and/or known indicia of attributes), the system may determine a likelihood of a dataset having a given property that may affect the effectiveness of a given model.

In some aspects, systems and methods for minimizing development time in artificial intelligence models by automating model selection based on dataset fittings of time-series data prior to hyperparameter optimization are described. For example, the system may receive a first dataset. The system may generate a first feature input based on the first dataset. The system may input the first feature input into a first plurality of statistical routines to determine a first plurality of respective outputs, wherein the first plurality of statistical routines performs a respective first statistical analysis of the first feature input, wherein each of the first plurality of statistical routines is based on a first respective algorithm. The system may determine a first aggregate statistical profile for the first dataset based on the first plurality of respective outputs. The system may select, based on the first aggregate statistical profile, a first untrained model from a first plurality of untrained models for training, wherein the first plurality of untrained models comprises respective algorithms for time-series forecasting and wherein each of the first plurality of statistical routines comprises default hyperparameter tuning. The system may, based on selecting the first untrained model, tune a first hyperparameter of the first untrained model using the first dataset.

In some aspects, systems and methods for automating model selection based on dataset fittings of time-series data that comprises non-standardized variance prior to hyperparameter optimization are described. For example, the system may receive a first dataset, wherein the first dataset comprises time-series data having a sequence of datapoints at equally spaced points in time over a dataset time range. The system may select a statistical profile type to identify in the first dataset. The system may retrieve a statistical model corresponding to the statistical profile type. The system may determine a first statistical profile for the first dataset based on the statistical model. The system may select, based on the first statistical profile, a first untrained model from a first plurality of untrained models for training, wherein the first plurality of untrained models comprises respective algorithms for time-series forecasting and wherein each of the first plurality of untrained models comprises default hyperparameter tuning. The system may, based on selecting the first untrained model, tune a first hyperparameter of the first untrained model using the first dataset.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram of time-series data, in accordance with one or more embodiments.

FIG. 1B shows an illustrative user interface for automating model selection and hyperparameter optimization, in accordance with one or more embodiments.

FIGS. 2A-D show illustrative diagrams for automating model selection based on dataset fittings of time-series data prior to hyperparameter optimization, in accordance with one or more embodiments.

FIG. 3 shows illustrative components for a system used to automate model selection based on dataset fittings of time-series data prior to hyperparameter optimization, in accordance with one or more embodiments.

FIG. 4 shows a flowchart of the steps involved in automating model selection based on dataset fittings of time-series data prior to hyperparameter optimization, in accordance with one or more embodiments.

FIG. 5 shows a flowchart of the steps involved in automating model selection based on dataset fittings, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

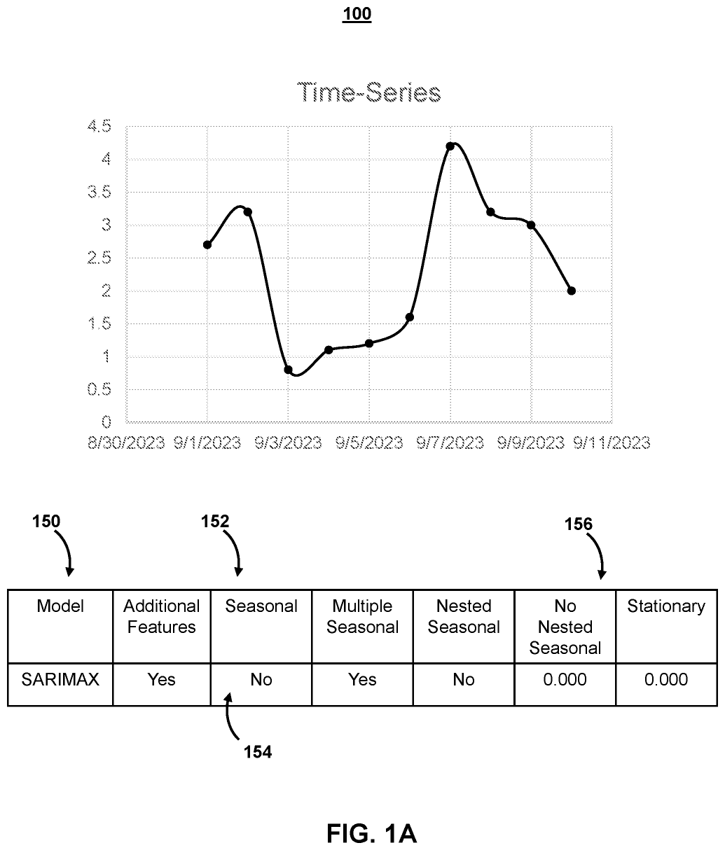

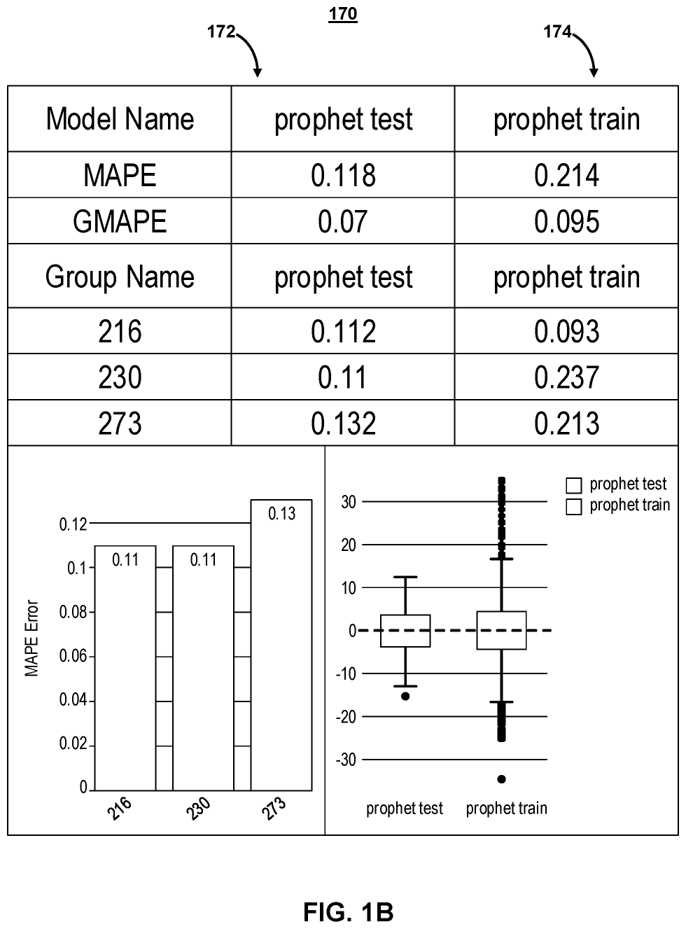

FIG. 1A shows an illustrative diagram of time-series data, in accordance with one or more embodiments. For example, dataset 100 may comprise data used to automate model selection based on dataset fittings of time-series data prior to hyperparameter optimization. Additionally or alternatively, a system may use dataset 100 to minimize development time in artificial intelligence models by automating model selection based on dataset fittings of time-series data prior to hyperparameter optimization. As described herein, a model development lifecycle may involve the various stages and processes involved in creating, training, evaluating, deploying, and/or maintaining models. It is a structured framework that helps guide the development of models in a systematic and effective manner.

As stated above, in the model development lifecycle, choosing the best model to fit a given dataset and optimizing its hyperparameters is an incredibly time-consuming and tedious process. This is particularly true for time-series data. For example, in time-series forecasting, some models will be better suited to fit a given dataset of certain attributes, such as the seasonal periods, presence of trends, and/or smoothness of the data. As such, certain time-series forecasting models may not be effective if there is no seasonality present in the data, whereas other time-series forecasting models may be very effective if the dataset is stationary. Accordingly, information about these attributes (e.g., a profile) of the time-series dataset may be used to help determine which model may be most effective at fitting a given dataset.

Fitting a dataset in artificial intelligence models may refer to the process of training a model using available data. Before fitting a dataset, the system may need to preprocess the data to make it suitable for training. This includes tasks such as handling missing values, scaling/normalizing features, encoding categorical variables, and splitting the dataset into training and testing sets. The system may then select an algorithm or model that is appropriate for a task. The choice of the model depends on the type of problem (classification, regression, clustering, etc.) and the characteristics of the data. The system may create an instance of the chosen model and configure its hyperparameters. Hyperparameters control various aspects of the learning process, and the system may need to experiment with different values to achieve optimal performance. The system may then use training data to train (fit) the model. This involves presenting the input features and corresponding target labels (or output) to the model so that it can learn the underlying patterns in the data. During training, the model may use a loss function to measure how well it is performing compared to the actual target values. The optimization algorithm (like stochastic gradient descent) then adjusts the model's parameters (weights and biases) to minimize this loss function. The training process is usually performed in iterations or epochs. In each iteration, the model updates its parameters based on a subset of the training data. This helps the model gradually improve its performance. After each epoch, the system can evaluate the model's performance on a validation set. This helps the system monitor how well the model is generalizing the data it has not seen before.

For example, the system may receive a first dataset, wherein the first dataset comprises one or more categories of data trends. A dataset may comprise a structured collection of datapoints, usually organized into rows and columns, that is used for various purposes, including analysis, research, and training machine learning models. Datasets contain information related to a specific topic, domain, or problem and are used to extract meaningful insights or to train and evaluate algorithms and models. In the context of machine learning, a dataset typically consists of two main components: features and labels. Features (or attributes) are the characteristics or variables that describe each datapoint. Features are represented as columns in a tabular dataset. For example, if the system is working with a dataset of houses, features could include attributes like the number of bedrooms, square footage, location, etc. Labels, in contrast, may comprise targets and/or responses. For example, in supervised learning tasks, each datapoint often has an associated label that represents the output or target value the system wants the model to predict. For instance, if the system is building a model to predict house prices, the labels would be the actual prices of the houses in the dataset. Datasets come in various formats and sizes, ranging from small tables with a few rows and columns to large and complex databases containing millions of records. They can be generated manually, collected from real-world sources, or obtained from publicly available repositories. Common types of datasets include structured datasets (e.g., tabular datasets with rows and columns, often stored in formats like CSV (Comma-Separated Values), Excel spreadsheets, or databases); image datasets (e.g., collections of images, often used for computer vision tasks. Each image is treated as a datapoint, and the pixels constitute the features); text datasets (e.g., textual data, such as reviews, articles, or tweets, which can be used for natural language processing (NLP) tasks); time-series datasets (e.g., sequences of datapoints ordered by time, such as stock prices, weather measurements, or sensor readings); and graph datasets (e.g., data organized in a graph structure, with nodes and edges representing relationships between entities). Datasets are fundamental for various data-driven tasks, including exploratory data analysis, statistical analysis, and machine learning model development and evaluation.

Dataset 100 may comprise time-series data. As described herein, “time-series data” may include a sequence of datapoints that occur in successive order over some period of time. In some embodiments, time-series data may be contrasted with cross-sectional data, which captures a point in time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time-series analysis. For example, a time-series analysis may be useful to see how a given asset, security, and/or value related to other content changes over time. It can also be used to examine how the changes associated with the chosen datapoint compare to shifts in other variables over the same time period. For example, with regard to retail loss, the system may receive time-series data for the various sub-segments indicating daily values for theft, product returns, etc.

The time-series analysis may determine various trends, such as a secular trend, which describes the movement along the term; a seasonal variation, which represents seasonal changes; cyclical fluctuations, which correspond to periodical but not seasonal variations; and irregular variations, which are other nonrandom sources of variations of series. The system may maintain correlations for this data during modeling. In particular, the system may maintain correlations through non-normalization, as normalizing data inherently changes the underlying data that may render correlations, if any, undetectable and/or lead to the detection of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches depend heavily on the normalization choices. Thus, normalization may lead to lower model performance and more model errors. The use of a non-parametric bias test alleviates the need for normalization while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time-series data as a data stream. A given increment (or instance) of the time-series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays, such as Easter and Lunar New Year, fall in different periods in each year; hence, they will distort observations. Also, year-to-year values will be biased by any changes in seasonal patterns that occur over time. For example, consider a comparison between two consecutive March months (i.e., compare the level of the original series observed in March for 2023 and 2024). This comparison ignores the moving holiday effect of Easter. Easter occurs in April for most years, but if Easter falls in March, the level of activity can vary greatly for that month for some series. This distorts the original estimates. A comparison of these two months will not reflect the underlying pattern of the data. The comparison also ignores trading day effects. If the two consecutive months of March have a different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may, in some cases, be normalized to account for this issue, the normalization of one data stream segment (e.g., for one component model) may affect another data stream segment (e.g., for another component model). Individual normalizations may distort the relationship and correlations between the data, leading to issues and negative performance of a composite data model.

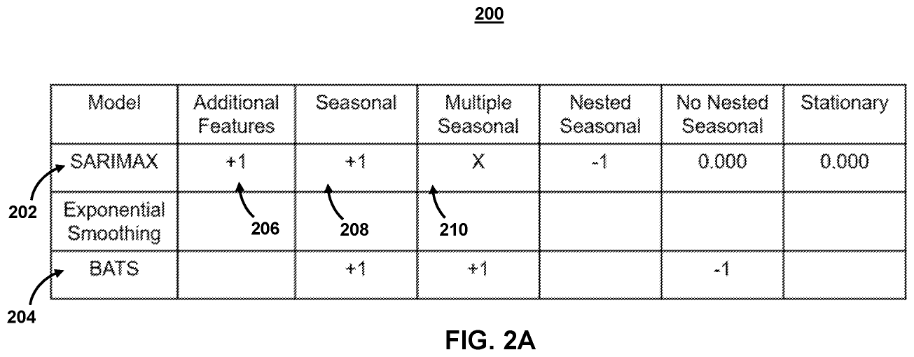

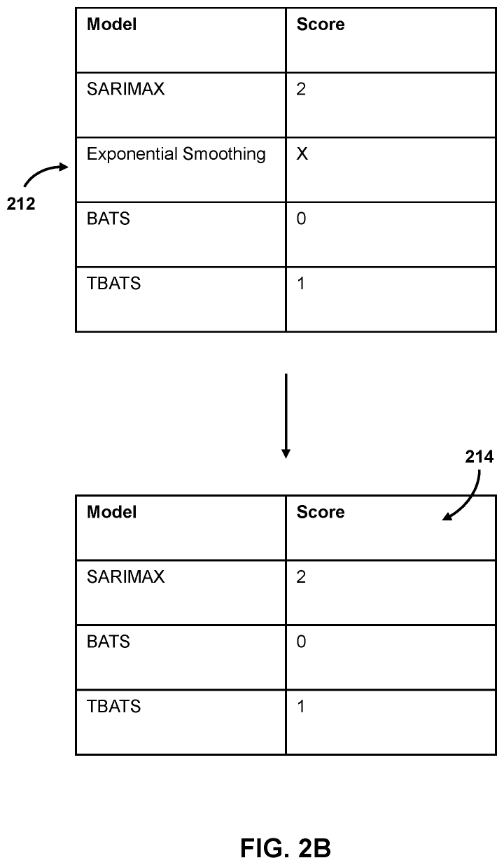

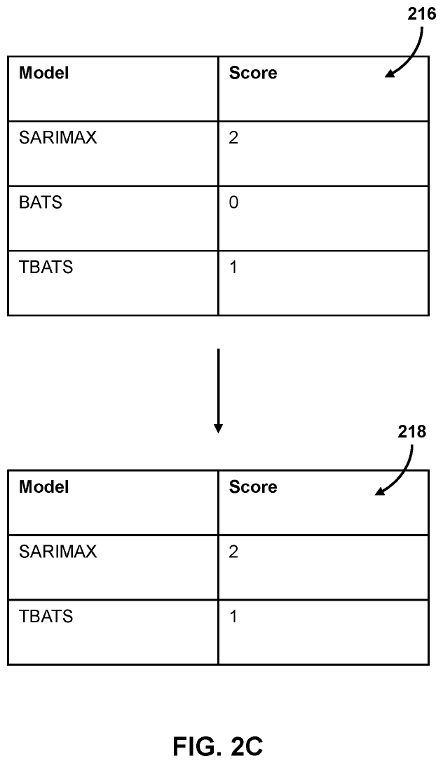

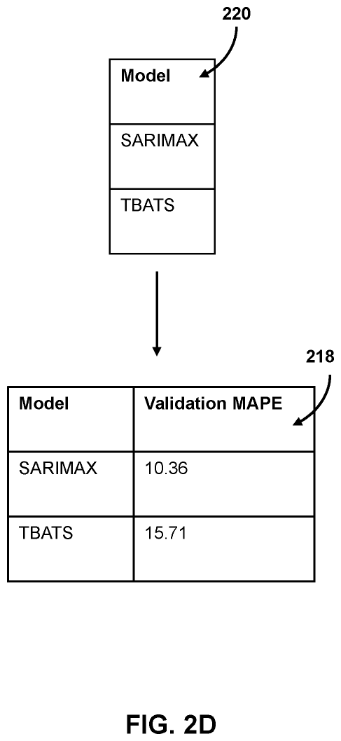

Table 150 may indicate outputs of a plurality of statistical models. For example, each row of table 150 may correspond to a model used to generate predictions based on a given dataset (e.g., “SARIMAX” in table 150), whereas each column of table 150 may correspond to a given statistical model that performs a different statistical analysis. For example, a first model of the plurality of statistical models (e.g., corresponding to column 152) may determine a value used to predict seasonality in data. The system may then use the value (e.g., value 154) to apply a score (e.g., score 206 (FIG. 2A)).

As referred to herein, a statistical analysis may encompass techniques used to analyze data and extract meaningful insights. These techniques help researchers, analysts, and data scientists understand patterns, relationships, and trends in data. In some embodiments, the system may determine whether data is spiky based on value 156.

For example, for automated model selection for time-series datasets, it is important to be able to determine whether or not the dataset contains “spiky” data-data that contains large swings, as certain time-series models cannot be fit properly to data that exhibits spikiness. The system may achieve this by scanning a given dataset for periods of spikiness that are independent of the specific range of the overall dataset and do not use any measure of variance of the data.

For example, the system may receive a time-series dataset. The system may then determine a number of points to check within a sliding window across the dataset, as well as a maximum tolerable percent change with respect to the current range of the data in the sliding window that determines the threshold for calling data spiky (e.g., a “spiky threshold”), and its value may be between zero and one.

For this process, the system iterates through the time-series dataset from the beginning, choosing a sliding window of a size of the number (N) of points the user selected. For each sliding window of N points, the system finds the range between the maximum and minimum values in the window. The system then determines the successive differences between each value of the points in the window and divides them by the window's range. If the absolute value of any of these values is greater than the spiky threshold value set by the user, the system exits out of the process and returns the dataset with an indication that it contained spiky data. If it ran to completion without identifying any spiky data, the system exits and returns an indication that it did not identify spiky data at the given parameters.

One type or category of statistical analysis is descriptive statistics. Descriptive statistics summarize and describe the main features of a dataset. This includes measures like mean, median, mode, standard deviation, variance, and percentiles. Descriptive statistics provide a basic overview of the data's central tendency, variability, and distribution. Table 150 may list these results as an array of data values that comprises an aggregate statistical profile for a given model, wherein the given model may be used to generate predictions based on the dataset.

Another type of statistical analysis is inferential statistics. Inferential statistics involves making predictions or drawing conclusions about a population based on a sample of data. Techniques like hypothesis testing, confidence intervals, and regression analysis are used to infer insights about larger datasets. Another type of statistical analysis is hypothesis testing. Hypothesis testing is used to make decisions about whether a particular hypothesis about a population is likely true or not. It involves comparing sample data to a null hypothesis and assessing the likelihood of observing the data if the null hypothesis is true.

Another type of statistical analysis is regression analysis. Regression analysis is used to understand the relationship between one or more independent variables (features) and a dependent variable (target). It helps model the relationship and predict the value of the dependent variable based on the values of the independent variables. Another type of statistical analysis is analysis of variance (ANOVA). ANOVA is used to analyze the differences among group means in a dataset. It is often used when there are more than two groups to compare. ANOVA assesses whether the means of different groups are statistically significant. Another type of statistical analysis is a chi-square test. The chi-square test is used to determine if there is a significant association between categorical variables. It is commonly used to analyze contingency tables and assess whether observed frequencies are significantly different from expected frequencies. Another type of statistical analysis is time-series analysis. Time-series analysis focuses on datapoints collected over time. Techniques like moving averages, exponential smoothing, and autoregressive integrated moving average (ARIMA) models are used to analyze trends, seasonality, and patterns in time-series data. Another type of statistical analysis is cluster analysis. Cluster analysis is used to group similar datapoints together based on their characteristics. It is often used for segmentation and pattern recognition in unsupervised learning tasks.

Another type of statistical analysis is factor analysis. Factor analysis is used to identify patterns of relationships among variables. It aims to reduce the number of variables by grouping them into latent factors that explain the underlying variance in the data. Another type of statistical analysis is principal component analysis (PCA). PCA is a dimensionality reduction technique that transforms high-dimensional data into a lower-dimensional space while retaining as much variance as possible. It is commonly used to reduce noise and extract important features from data.

FIG. 1B shows an illustrative user interface for automating model selection and hyperparameter optimization, in accordance with one or more embodiments. For example, user interface 170 may represent an interface used to perform model selection and/or adjust hyperparameter optimization. For example, user interface 170 may be used to review model and/or hyperparameter performance (e.g., in order to train, tune, and/or fit models and/or hyperparameters).

The system may perform hyperparameter tuning to optimize the model's settings for better performance. For example, the system may compare test performance 172, which may comprise a performance performed by a model on test data to train performance 174, which may comprise a performance performed by a model on test data to train performance. Once the training is complete and the system meets a threshold level of performance, the system can evaluate its performance on a separate testing dataset. This gives the system a final assessment of how well the model is expected to perform on new, unseen data. If the model meets the performance requirements, the system can deploy it to make predictions on new data. This may involve integrating the trained model into another application or system. The fitting process involves a balance between underfitting (when the model is too simple to capture the underlying patterns) and overfitting (when the model learns noise in the training data and performs poorly on new data). Regularization techniques and careful model selection can help mitigate these issues. Overall, fitting a dataset involves selecting a model, training it on the data, monitoring its performance, and optimizing its settings for the best results.

As referred to herein, a “modeling error” or simply an “error” may correspond to an error in the performance of the model. In some embodiments, an error may be used to determine an effect on the performance of a model. For example, an error in a model may comprise an inaccurate or imprecise output or prediction for the model. This inaccuracy or imprecision may manifest as a false positive or a lack of detection of a certain event. These errors may occur in models corresponding to a particular hyperparameter, which results in inaccuracies for predictions and/or output based on the hyperparameter, and/or the errors may occur in models corresponding to an aggregation of multiple hyperparameters that result in inaccuracies for predictions and/or outputs based on errors received in one or more of predictions of the plurality of hyperparameters and/or an interpretation of the predictions of the models based on the plurality of hyperparameters.

Hyperparameter tuning is the process of selecting the optimal values for hyperparameters in a machine learning model. Hyperparameters are parameters that are set before the learning process begins and control various aspects of the training process. They are not learned from the data but are determined by the user or data scientist based on domain knowledge, experimentation, and heuristics. Some examples of hyperparameters in machine learning algorithms include learning rate, regularization strength, number of hidden units or layers in a neural network, kernel parameters in support vector machines, and so on.

Hyperparameter tuning is important because the performance of a machine learning model is highly dependent on the values of these hyperparameters. Poorly chosen hyperparameters can lead to suboptimal model performance, including overfitting or underfitting. The goal of hyperparameter tuning is to find the set of hyperparameters that result in the best possible performance on the validation or test dataset.

There are several methods for hyperparameter tuning, including grid searching. This involves specifying a grid of possible hyperparameter values and systematically trying out all combinations of values. It is simple but can be computationally expensive. Another example of hyperparameter tuning is random search. Instead of trying all possible combinations, random search samples a fixed number of random combinations from the hyperparameter space. This can be more efficient than grid search. Another example of hyperparameter tuning is Bayesian optimization. This is a more sophisticated approach that builds a probabilistic model of the relationship between hyperparameters and model performance. It then uses this model to intelligently select the next set of hyperparameters to try. Another example of hyperparameter tuning is gradient-based optimization. Some frameworks allow for using gradient-based optimization techniques to directly optimize hyperparameters alongside the model parameters.

The process of hyperparameter tuning involves a balance between exploration and exploitation. Exploring different hyperparameter values helps to find a better region in the hyperparameter space, while exploiting promising regions helps to refine the hyperparameter settings for optimal performance. Overall, hyperparameter tuning is a crucial step in the machine learning pipeline to achieve the best possible model performance on new, unseen data.

FIGS. 2A-D show illustrative diagrams for automating model selection based on dataset fittings of time-series data prior to hyperparameter optimization, in accordance with one or more embodiments.

For example, FIG. 2A shows matrix 200, which includes information about attributes of a dataset (e.g., dataset 100 (FIG. 1)), used to help determine which model may be most effective at fitting a given dataset. Matrix 200 includes a plurality of rows and columns. The values in the plurality of rows and columns may constitute an aggregate statistical profile for a dataset that comprises a series of values corresponding to a plurality of respective outputs from a first plurality of statistical routines.

The series of values used to populate matrix 200 may be based on a respective effectiveness of a plurality of model types for generating predictions based on the one or more categories of data trends. For example, the system may input a first feature input into a first plurality of statistical routines to determine a first plurality of respective outputs, wherein the first plurality of statistical routines performs a respective first statistical analysis of the first feature input and wherein each of the first plurality of statistical routines is based on a first respective algorithm.

The system may score the various models using a profiling model. The profiling model may be used to understand the structure, content, and quality of a dataset. For example, the primary goal of data profiling is to gather insights about the data in order to make informed decisions about model selecting, hyperparameter tuning, etc. In particular, the profiling model may rely on a scoring policy that indicates which scores should be attributed to different profiles for different models (i.e., the results of the various statistical analyses). In some embodiments, the scoring policy may indicate which scores should be attributed to the plurality of respective outputs from a plurality of statistical routines performing respective first statistical analysis on a dataset (or a feature input based thereon). For example, each of the plurality of statistical routines may be based on a respective algorithm (e.g., to perform a different statistical analysis (e.g., to determine seasonality, multiple seasonality, nested seasonality, stationary trends, spiky data, smooth data, and/or additional features)).

In some embodiments, the profiling model may be based on a scoring policy. As described herein, a scoring policy may refer to a scoring function and/or scoring algorithm used to assign scores or ranks to different instances or datapoints (e.g., outputs of models) based on certain criteria. These criteria may be defined based on the statistical analysis. The purpose of a scoring policy is to enable decision-making and/or prioritization (e.g., regarding model training, hyperparameter tuning, etc.) based on the scores assigned to the instances.

The scoring of an output of a model in the context of modeling may refer to the prediction, classification, or response that the model generates based on the input features it has been provided. In other words, the model's output is the result of applying its learned patterns and relationships to the input data. Similarly, the scoring policy may use one or more types of classification, ranking, and/or anomaly detection.

For example, in binary classification, a scoring policy assigns scores to instances to determine their likelihood of belonging to one of the two classes. In non-binary classification, the scoring policy may assign scores to instances to determine their likelihood of belonging to a plurality of classes. Common scoring policies for classification tasks include logistic regression scores, probability scores, or decision function scores from support vector machines. In ranking tasks, instances are assigned scores to determine their order or position in a ranked list. This is common in information retrieval, search engines, and recommendation systems. For instance, a scoring policy might assign higher scores to documents that are more relevant to a search query. In reinforcement learning, a scoring policy is often represented by a policy network that assigns scores to different actions in a given state. This helps in determining the best action to take based on the expected future rewards. In ensemble methods like random forests or gradient boosting, multiple base models are combined to make predictions. The scoring policy involves aggregating the predictions from individual models to make a final decision. The scoring policy may score model outputs, where the models perform one or more statistical analyses on a dataset.

Row 202 may list a plurality of different categories for data trends. The system may determine, based on the respective models, whether the dataset corresponds to one or more categories of data trends and provide a score that indicates a positive effect (e.g., score 206), disqualifying effect (e.g., score 208), and/or negative effect (e.g., score 210) for each category based on how that category (or lack thereof) affects a given model (e.g., model 204).

Determining trends in data involves identifying patterns and changes in values over time or across different datapoints. Detecting trends is important for understanding the underlying dynamics of a dataset and making informed decisions. In time-series data, trends refer to the long-term patterns or movements that persist over an extended period of time. Identifying and understanding different types of trends is important for making predictions, forecasting, and decision-making. One category of trends is an upward trend (increasing trend).

An upward trend occurs when the data values consistently increase over time. This suggests a positive relationship and indicates growth or improvement in the variable being measured. Another category of trends is a downward trend (decreasing trend). A downward trend is the opposite of an upward trend. Data values consistently decrease over time, indicating a negative relationship and potential decline in the variable. Another category of trends is a horizontal or flat trend. A flat trend occurs when data values remain relatively stable over time, showing little to no change. This could indicate a period of stability or equilibrium. Another category of trends is a seasonal trend. A seasonal trend involves repeated patterns that occur at regular intervals, often corresponding to seasons, months, days of the week, or specific events. Seasonal trends can be seen in sales data, temperature readings, and more. Another category of trends is a cyclical trend. Cyclical trends are longer-term patterns that do not have a fixed periodicity like seasons. They typically extend beyond a year and are influenced by economic, business, or social cycles. Cyclical patterns can be observed in economic data, such as stock market fluctuations. Another category of trends is a damped trend. A damped trend occurs when an increasing or decreasing trend starts to level off over time. It suggests that the initial strong trend is weakening, possibly due to various influencing factors. Another category of trends is a step trend. A step trend involves sudden shifts or jumps in the data values, often due to external events or structural changes. Step trends can be challenging to identify and model accurately. Another category of trends is an exponential trend. An exponential trend occurs when the data values grow or decline at an exponential rate. This suggests a compounding effect over time. Another category of trends is a linear trend. A linear trend is a straight-line relationship between the data values and time. The slope of the line indicates the rate of change. Another category of trends is a quadratic trend. A quadratic trend is a curve that fits the data better than a straight line. It indicates a changing rate of change over time.

However, these attributes do not necessarily have a linear relationship with the effectiveness of a model. Moreover, in some cases, a dataset may have conflicting (or complimentary) attributes that weigh on the effectiveness of a given model. As such, the systems and methods gather information about a time-series profile of a given dataset using a plurality of statistical tests to determine details such as stationarity, seasonality, and/or presence of trends. The systems and methods may then apply a scoring policy to the time-series profile to determine a score for each model. The systems and methods may then use the scoring policy to determine how a given time-series model may be affected (e.g., whether it is benefited, harmed, and/or disqualified entirely) by the details present in the time-series profile. The systems and methods may then filter, prioritize, and/or select models based on attributes of the time-series profile. Notably, an initial disqualification of a model prevents further time and/or resources related to testing and/or training a given model. For example, as shown in FIG. 2B, the model corresponding to exponential smoothing has been disqualified based on disqualifying effect 212.

In contrast, as shown in FIG. 2C, models that are not disqualified may be continued to be scored (e.g., scores 216) to allow for non-binary classification and/or analysis to account for the conflicting (or complimentary) attributes that weigh on the effectiveness of a given model. That is, the system may aggregate the various values returned by the plurality of statistical routines into a series of scores. While models that are disqualified (e.g., model 214) are eliminated, once all remaining models are scored, the system may select the top-scored models (e.g., scores 218) to be fit and tuned, and the model with the best validation score may be selected for use by a user.

As shown in FIG. 2D, the system may select high scoring models 220 for fitting based on a dataset (e.g., dataset 100 (FIG. 1)) and then evaluate the models (e.g., evaluations 222). By doing so, the system automates the profiling of the time-series dataset (which gathers information about what makes this dataset unique) and automatically selects and fits the best-suited models to the specific time-series profile. As such, the system saves countless hours for any user who wishes to apply time-series forecasting techniques to a given dataset and allows for the democratization of artificial intelligence by reducing the barrier to entry for many users to start forecasting.

For example, the system may select, based on the respective effectiveness of the plurality of model types, a first untrained model from a first plurality of untrained models for training, wherein the first plurality of untrained models comprises respective algorithms for time-series forecasting and wherein each of the first plurality of untrained models comprises default hyperparameter tuning. An untrained model, which may be referred to as a “raw” or “initial” model, is a model that has not yet been exposed to any (or has been exposed to limited) training data or learning process. In its untrained state, the model lacks the knowledge or parameters necessary to make accurate predictions or classifications. When a model is first created, its parameters (weights and biases) are usually initialized randomly or with default values. At this point, the model is essentially a blank slate, and its predictions are based on these initial parameter values, which are unlikely to provide meaningful results. For example, consider a neural network designed to classify images of animals. Before training, this untrained neural network would not know how to distinguish between different animals because it has not learned any patterns from data.

To make an untrained model useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data.

Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

Based on selecting the first untrained model, the system may tune a first hyperparameter of the first untrained model using the first dataset to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behavior, and/or historical interactions.

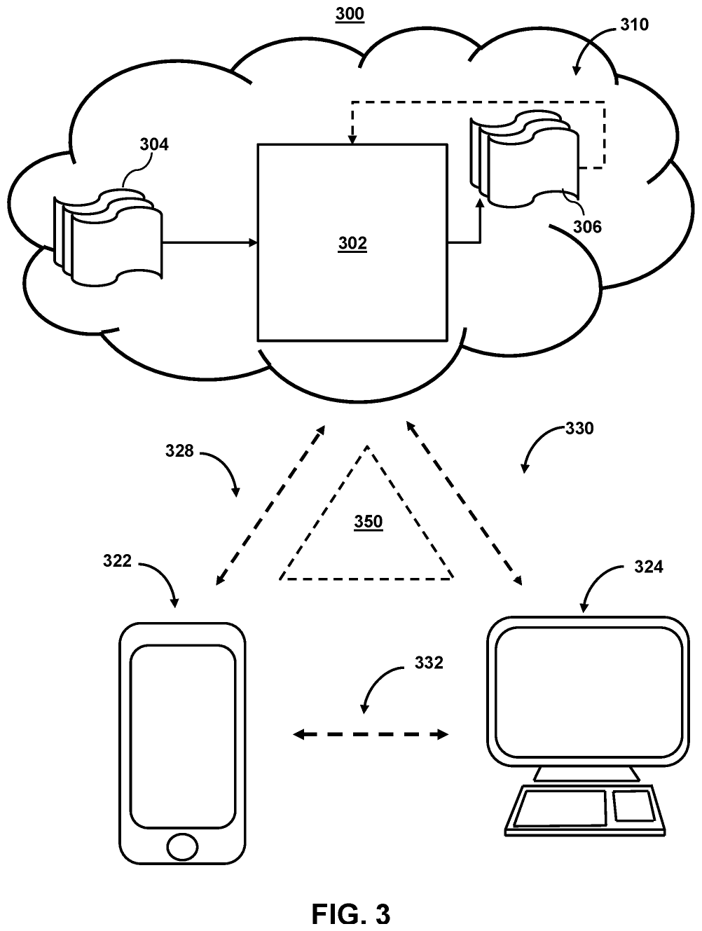

FIG. 3 shows illustrative components for a system used to automate model selection based on dataset fittings of time-series data prior to hyperparameter optimization, in accordance with one or more embodiments. For example, FIG. 3 may show illustrative components for minimizing development time in artificial intelligence models by automating model selection based on dataset fittings of time-series data prior to hyperparameter optimization. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., recommendations, queries, and/or notifications).

Additionally, as mobile device 322 and user terminal 324 are shown as a touchscreen smartphone and personal computer, respectively, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., one or more categories of data trends and/or other predictions).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302, where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., one or more categories of data trends and/or other predictions).

In some embodiments, the model (e.g., model 302) may automatically perform actions based on outputs 306. In some embodiments, the model (e.g., model 302) may not perform any actions. The output of the model (e.g., model 302) may be used to generate recommendations and/or other predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications is in place.

In some embodiments, the system architecture may use a microservice approach. Such systems may use two types of layers: Front-End Layer and Back-End Layer, where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDoS protection, and API layer 350 may use RESTful APIs as standard for external integration.

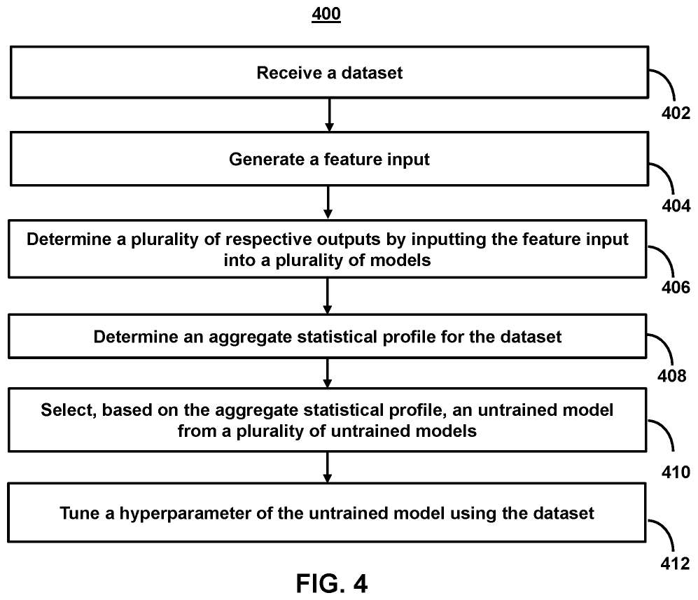

FIG. 4 shows a flowchart of the steps involved in automating model selection based on dataset fittings of time-series data prior to hyperparameter optimization, in accordance with one or more embodiments. For example, the system may use process 400 (e.g., as implemented on one or more system components described above) in order to minimize development time in artificial intelligence models by automating model selection based on dataset fittings of time-series data prior to hyperparameter optimization.

At step 402, process 400 (e.g., using one or more components described above) receives a dataset. For example, the system may receive a first dataset. For example, the first dataset may comprise payment card transaction data over a given time period. For example, payment card transaction data refers to the records of financial transactions made using credit cards, debit cards, and/or other electronic payments. These transactions involve the exchange of goods or services in return for payment, and the details of each transaction are recorded by the credit card issuer and the merchant involved. Transaction data is highly valuable for various purposes, including financial analysis, fraud detection, and consumer behavior analysis.

At step 404, process 400 (e.g., using one or more components described above) generates a feature input. For example, the system may generate a first feature input based on the first dataset. In the context of modeling, a feature input (often simply referred to as a “feature”) is a specific attribute or variable that is used as an input to a model for making predictions or classifications. Features are the measurable characteristics of the data that the machine learning algorithm uses to learn patterns and relationships in the data. In a dataset, each datapoint (also known as an observation or instance) is described by a set of features. These features represent the input variables that the model uses to make predictions or decisions. The goal of feature engineering is to select and transform relevant features that can help the model capture the underlying patterns in the data and improve its predictive performance.

At step 406, process 400 (e.g., using one or more components described above) determines a plurality of respective outputs by inputting the feature input into a plurality of statistical routines. For example, the system may input the first feature input into a first plurality of statistical routines to determine a first plurality of respective outputs, wherein the first plurality of statistical routines performs a respective first statistical analysis of the first feature input, wherein each of the first plurality of statistical routines is based on a first respective algorithm.

In some embodiments, each routine of the plurality of statistical routines may test for a different statistical variation (e.g., smoothness, spiky data, seasonality, etc.). To determine the statistical variation for the first model over the first time period, the system may need to calculate descriptive statistics that provide insights into the variability of the data. For example, the system may gather the data (e.g., from the first dataset) over the first time period. This could be any relevant metric that the system wants to analyze, such as accuracy, error rate, revenue, etc., as well as other statistical metrics (e.g., mean, average, standard deviation, etc.). For example, the system may calculate descriptive statistics such as mean, variance, and/or standard deviation. To determine a mean, the system may add up all the datapoints and divide by the number of datapoints to get the average. The mean provides an overall sense of central tendency. To determine variance, for each datapoint, the system calculates the squared difference from the mean. The system may then sum up these squared differences and divide by the number of datapoints. Variance measures how much the datapoints spread out from the mean. For standard deviation, the system takes the square root of the variance. The standard deviation is a commonly used measure of dispersion or spread. For example, the system may determine a first time period for a first model of the first plurality of statistical routines. The system may determine a first statistical variation for the first model over the first time period. The system may determine a respective output of the first plurality of respective outputs for the first model based on the first statistical variation.

At step 408, process 400 (e.g., using one or more components described above) determines an aggregate statistical profile for the dataset. For example, the system determines an aggregate statistical profile for the dataset based on the first plurality of respective outputs. The system may aggregate the first plurality of respective outputs, which are generated based on a profiling model, to determine a first aggregate statistical profile for the first dataset. In some embodiments, the aggregate statistical profile may comprise a matrix. For example, the system may input the first plurality of respective outputs into the profiling model to determine the first aggregate statistical profile for the first dataset by generating a profile matrix for the first dataset. The system may then populate values of the profile matrix based on a comparison of the first plurality of respective outputs and respective model requirements for the first plurality of untrained models.

At step 410, process 400 (e.g., using one or more components described above) selects, based on the aggregate statistical profile, an untrained model. For example, the system may select, based on the first aggregate statistical profile, a first untrained model from a first plurality of untrained models for training, wherein the first plurality of untrained models comprises respective algorithms for time-series forecasting and wherein each of the first plurality of untrained models comprises default hyperparameter tuning. For example, default hyperparameter tuning may refer to the process of using the default parameter values provided by a machine learning algorithm or library without explicitly adjusting them. Hyperparameters are parameters that are set before the training process begins and control aspects of the training process itself rather than being learned from the data, like model parameters.

When the system uses a machine learning algorithm or model library, it may use default hyperparameter values that are chosen based on some reasonable assumptions or heuristics. These default values are meant to work reasonably well for a wide range of tasks and datasets. Default hyperparameter tuning involves training and evaluating the model using these default values without any further customization.

Using the aggregate statistical profile, the system may filter, score, and/or disqualify models. In some embodiments, the system may compare scores to one or more thresholds to determine whether or not to filter, score, and/or disqualify models. For example, when selecting, based on the first aggregate statistical profile, the first untrained model from the first plurality of untrained models for training the system may compare a first respective output of the first plurality of respective outputs to a threshold value. The system may then determine a difference between the first respective output and the threshold value, wherein selecting the first untrained model is based on the difference. The system may select the threshold based on characteristics of the dataset (e.g., size, type, age, etc.).

In some embodiments, the system may select, based on the first aggregate statistical profile, the first untrained model from the first plurality of untrained models for training by filtering the first plurality of untrained models based on the first aggregate statistical profile to generate a filtered subset of the first plurality of untrained models. The system may then select the first untrained model from the filtered subset. For example, the system may disqualify and/or filter some models from contention in order to preserve resources.

In some embodiments, the system may perform this filtering based on other information about the dataset not included in the aggregate statistical profile. For example, when selecting, based on the first aggregate statistical profile, the first untrained model from the first plurality of untrained models for training, the system may filter the first plurality of untrained models based on an age of the first dataset to generate a filtered subset of the first plurality of untrained models.

The system may select the first untrained model from the filtered subset. Additionally or alternatively, the system may select, based on the first aggregate statistical profile, the first untrained model from the first plurality of untrained models for training by filtering the first plurality of untrained models based on a reliability of the first dataset to generate a filtered subset of the first plurality of untrained models. The system may then select the first untrained model from the filtered subset. Additionally or alternatively, the system may select, based on the first aggregate statistical profile, the first untrained model from the first plurality of untrained models for training by ranking the first plurality of untrained models based on the first aggregate statistical profile to generate a ranked order of the first plurality of untrained models. The system may then select the first untrained model based on the ranked order.

In some embodiments, the system may consider the amount of resources involved in training a particular model. For example, the system may select, based on the first aggregate statistical profile, the first untrained model from the first plurality of untrained models for training by determining respective training time predictions for each of the first plurality of untrained models based on the first aggregate statistical profile. The system may then select the first untrained model based on the respective training time predictions. Additionally or alternatively, the system may select, based on the first aggregate statistical profile, the first untrained model from the first plurality of untrained models for training by determining respective performance predictions for each of the first plurality of untrained models based on the first aggregate statistical profile. The system may select the first untrained model based on the respective performance predictions. Additionally or alternatively, the system may select, based on the first aggregate statistical profile, the first untrained model from the first plurality of untrained models for training by determining respective predictions for a number of hyperparameters requiring training for each of the first plurality of untrained models based on the first aggregate statistical profile. The system may select the first untrained model based on the respective predictions for the number of hyperparameters requiring training. Additionally or alternatively, the system may select, based on the first aggregate statistical profile, the first untrained model from the first plurality of untrained models for training by determining respective sample size requirements for training for each of the first plurality of untrained models based on the first aggregate statistical profile. The system may then select the first untrained model based on the respective sample size requirements for training. Additionally or alternatively, the system may select, based on the first aggregate statistical profile, the first untrained model from the first plurality of untrained models for training by determining respective processing power requirements for training for each of the first plurality of untrained models based on the first aggregate statistical profile. The system may select the first untrained model based on the respective processing power requirements for training.

At step 412, process 400 (e.g., using one or more components described above) tunes a hyperparameter of the untrained model using the dataset. For example, the system may, based on selecting the first untrained model, tune a first hyperparameter of the first untrained model using the first dataset. To make an untrained model useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data.

Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

Based on selecting the first untrained model, the system may tune a first hyperparameter of the first untrained model using the first dataset to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behavior, and/or historical interactions.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

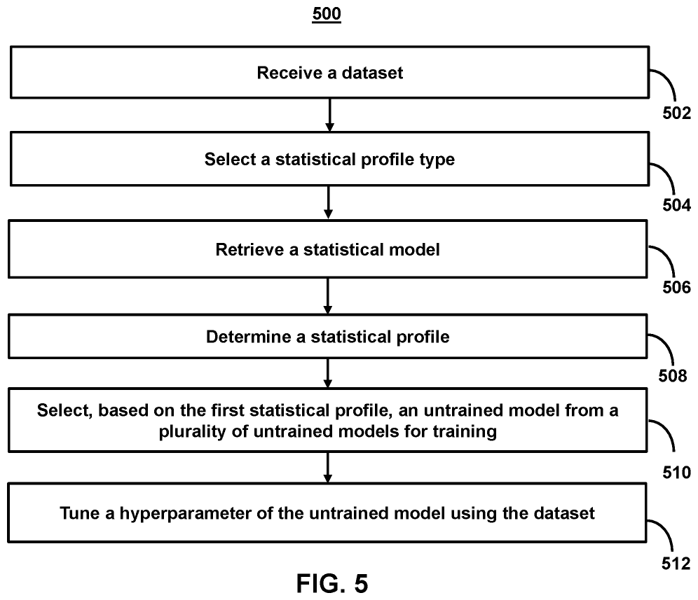

FIG. 5 shows a flowchart of the steps involved in automating model selection based on dataset fittings, in accordance with one or more embodiments. For example, the system may use process 500 (e.g., as implemented on one or more system components described above) in order to minimize development time in artificial intelligence models by automating model selection based on dataset fittings of time-series data that comprise non-standardized variance prior to hyperparameter optimization. For example, accurately detecting seasonality in time-series datasets is an incredibly difficult task, but it is important to many modeling tasks that require knowing the seasonality of the data. Furthermore, non-standardized variance, or simply “variance,” is a statistical measure that quantifies the spread or dispersion of a set of datapoints. It indicates how much the individual datapoints in a dataset deviate from the mean (average) of the dataset. In other words, it measures the extent to which datapoints are scattered around the central value. The system may select a model based on dataset fittings within environments featuring high amounts of variance and/or varying amounts of variance.

At step 502, process 500 (e.g., using one or more components described above) receives a dataset. For example, the system may receive a first dataset, wherein the first dataset comprises time-series data having a sequence of datapoints at equally spaced points in time over a dataset time range. A sequence of datapoints in time-series data may refer to a collection of observations or measurements recorded over a period of time at successive intervals. In a time series, each datapoint is associated with a specific time or timestamp, and the datapoints are ordered chronologically. Time-series data is commonly used to analyze and understand patterns, trends, and fluctuations that occur over time. The datapoints are recorded in a specific sequence based on time, and the order of the datapoints is crucial for analysis. Time-series data might include hourly, daily, monthly, or other regular intervals.

Each datapoint may be associated with a timestamp that indicates when the observation was made. These timestamps provide context for the data and allow for the analysis of temporal relationships. While many time series are collected at regular intervals (e.g., hourly measurements), there are cases where data might be collected at irregular intervals due to varying data availability or event-driven recording.

Time-series data often exhibits patterns, trends, and seasonality, which can be analyzed to gain insights into underlying processes. These patterns might be periodic (repeating at consistent intervals) or aperiodic (no consistent repeating pattern). Time-series data can also include anomalies or outliers, which are datapoints that deviate significantly from the expected pattern. Detecting anomalies is an important task in various applications, including fraud detection and equipment monitoring. Time-series data may include such examples as stock prices (e.g., daily closing prices of a company's stock over a period of time); temperature readings (e.g., hourly temperature measurements recorded by weather stations); website traffic (e.g., hourly or daily counts of visitors to a website); economic indicators (e.g., monthly unemployment rates, inflation rates, etc.); sensor readings (e.g., timestamped measurements from sensors in industrial processes or IoT devices); and/or medical monitoring (e.g., vital signs (heart rate, blood pressure) recorded at regular intervals for a patient).

At step 504, process 500 (e.g., using one or more components described above) selects a statistical profile type. For example, the system may select a statistical profile type to identify in the first dataset. For example, the system may determine different statistical profile types (e.g., categories of statistical profiles) such as seasonality, multiple seasonality, nested seasonality, stationary trends, spiky data, smooth data, and/or additional types. The system may use information about whether a dataset corresponds to a category to determine the best model and/or hyperparameter to use.

At step 506, process 500 (e.g., using one or more components described above) retrieves a statistical model. For example, the system may retrieve a statistical model corresponding to the statistical profile. For example, each of the plurality of statistical routines may be based on a respective algorithm (e.g., to perform a different statistical analysis (e.g., to determine seasonality, multiple seasonality, nested seasonality, stationary trends, spiky data, smooth data, and/or additional features)). The system may store a plurality of statistical models to determine various statistical profile types.

The system may determine a threshold percent change for the first dataset. In some embodiments, the system may receive an input of a time-series dataset for which the system would like to determine if there is spiky data present. The system may also need to input a number of points to check within a sliding window across the dataset, as well as a maximum tolerable percent change with respect to the current range of the data in the sliding window that determines the threshold for calling data spiky. This will be referred to as the “spiky threshold”, and its value can be between zero and one.

Percent change, also known as percentage change or relative change, is a measure used to express the relative difference between two values (e.g., values in datapoints) in terms of a percentage. It is often used to quantify how much a value has increased or decreased in comparison to its initial value. Percent change is particularly useful for comparing changes in quantities that may be of different scales or magnitudes.

The system may determine a first time range that is less than the dataset time range. For example, a time range in a dataset may refer to the period of time that the dataset covers. It defines the starting point and the ending point of the time period during which data was collected or recorded. A time range may provide context for understanding when the data was gathered and for interpreting the temporal relationships within the dataset.

In time-series data, which is data collected at successive time intervals, the time range is crucial for analyzing trends, patterns, and changes over time. The time range specifies the overall scope of the data and helps establish the context for any conclusions drawn from the data analysis. The system may generate windows of data within the range (e.g., that comprises subsets of the time period).

In some embodiments, the system may use one or more rolling windows or rolling ranges within the dataset. A rolling window, also known as a moving window or sliding window, is a technique used in time-series analysis and other data analysis tasks to compute statistics or perform calculations over a subset of datapoints within a defined window that “rolls” or moves through the dataset. The purpose of using a rolling window is to capture trends, patterns, or fluctuations that might not be apparent when considering the entire dataset at once.

The system may determine a first subset of the sequence of datapoints, wherein the first subset begins at a first datapoint in the sequence of datapoints and includes datapoints within the first time range from the first datapoint.

The system may determine a first maximum datapoint value of the first subset and a first minimum datapoint value of the first subset. The maximum value in a dataset may refer to the largest value among all the datapoints in that dataset. It represents the upper bound of the datapoints in terms of magnitude. Identifying the maximum value is useful for understanding the range of values present in the dataset and for various types of analysis, such as identifying outliers or assessing the upper limit of a variable's variation. The minimum value in a dataset may refer to the smallest value among all the datapoints in that dataset. It represents the lower bound of the datapoints in terms of magnitude. Identifying the minimum value is useful for understanding the range of values present in the dataset and for various types of analysis, such as identifying outliers or assessing the lower limit of a variable's variation.

The system may determine a first difference between the first maximum datapoint value and the first minimum datapoint value. To determine the difference between two datapoints, the system may subtract the value of one datapoint from the value of the other datapoint. The difference represents the numerical gap or distance between the two values.

The system may determine a second time range that is less than the dataset time range. For example, the system may iterate through the time-series dataset from the beginning, choosing a sliding window of a size of the number (N) of points as selected by the system. For each sliding window of N points, the system may find the range between the maximum and minimum values in the window. The system may then check the successive differences between each value of the points in the window and divide them by the window's range.

The system may determine a second subset of the sequence of datapoints, wherein the second subset begins at a second datapoint in the sequence of datapoints and includes datapoints within the second time range from the second datapoint and wherein the second datapoint is immediately after the first datapoint in the sequence of datapoints. The system may determine a second maximum datapoint value of the second subset and a second minimum datapoint value of the second subset. The system may determine a second difference between the second maximum datapoint value and the second minimum datapoint value.

The system may determine a percent change between the first subset and the second subset based on an absolute value of the first difference and the second difference. For example, if the absolute value of any of these values is greater than the spiky_threshold value set by the system, the system may exit out of the process and return a result that it identified the dataset contains spiky data. If the system runs to completion without identifying any spiky data, the system may exit and return results that it did not identify spiky data at the given parameters. The system may compare the percent change to the threshold percent change. The system may determine the first statistical profile of the first dataset based on comparing the percent change to the threshold percent change. The threshold percent change may comprise a number between zero and one.

In some embodiments, the system may generate a periodogram to generate the statistical profile using a Fisher G-test. For example, accurately detecting seasonality in time-series datasets is an incredibly difficult task, but it is important to many modeling tasks that require knowing the seasonality of the data. In some embodiments, the system may use a hybrid approach to discover candidate seasonal period values but confirms which value appears to be best by actually fitting a model to the dataset with all the candidate values.

For example, the system may generate a first periodogram by decomposing the sequence of datapoints using a Fourier transform. The system may receive an input from the system of a time-series dataset for which it intends to discover seasonal periods. Optionally, the system may use a time-series model that supports seasonal period values as a hyperparameter, but a SARIMA model may be used by default.

The system may create a periodogram by decomposing the time-series signal using a Fourier transform to detect underlying frequencies of regular oscillations in the dataset. A periodogram is used to visualize and analyze the frequency components present in a time-series signal. It is a graphical representation that provides insights into the frequency content of the signal, helping to identify periodic patterns, dominant frequencies, and other spectral characteristics. The periodogram is obtained by calculating the squared magnitude of the Discrete Fourier Transform (DFT) of a dataset. The DFT is a mathematical transformation that converts a time-domain signal into a frequency-domain representation, revealing the different frequency components within the signal.

To generate the periodogram, the system may collect time-series data by gathering a dataset of time-series measurements or observations. The system may apply the DFT to the time-series data to convert it from the time domain to the frequency domain. The system may then square the magnitude of each complex number resulting from the DFT. This process highlights the strength of each frequency component in the signal. The system may then plot the squared magnitudes against frequency to create the periodogram. The x-axis represents frequency, and the y-axis represents the power or intensity of each frequency component.

The system may process the first periodogram using a Fisher G-test to determine first results, wherein the first results comprise a seasonal period value. The system may use a Fisher G-test on the periodogram to determine statistically significant seasonal period values. The Fisher G-test, also known as Fisher's exact test or Fisher's G-test of independence, is a statistical test used to determine if there is a significant association between two categorical variables in a contingency table. It is an extension of Fisher's exact test for analyzing the independence of two categorical variables in cases where the sample size is small. The G-test is based on comparing the observed frequencies in a contingency table with the expected frequencies that would be expected if the variables were independent. The test assesses whether the observed distribution significantly deviates from what would be expected under the assumption of independence.

To perform the Fisher G-test, the system may gather data and organize it into a contingency table, which is a two-way table that cross-tabulates the frequencies of the two categorical variables. The system may calculate the expected frequencies for each cell of the contingency table, assuming independence between the variables. This is typically done using the product of row and column totals divided by the overall total. The system may calculate the G-statistic, which is a measure of the difference between the observed and expected frequencies, taking into account the sample size. The formula for the G-statistic depends on the specific variant of the test being used. The system may then determine the appropriate degrees of freedom for the test. This depends on the dimensions of the contingency table. The system may compare the calculated G-statistic with the critical value from the appropriate chi-squared distribution table. If the calculated G-statistic is greater than the critical value, it indicates a significant association between the variables. Alternatively, the system may calculate the p-value associated with the calculated G-statistic. If the p-value is below a chosen significance level (e.g., 0.05), the system may reject the null hypothesis and conclude that there is a significant association between the variables. The Fisher G-test is particularly useful when dealing with small sample sizes or when the expected cell frequencies in a traditional chi-squared test are too low for accurate testing.

The system may process the sequence of datapoints using an autocorrelation function to determine second results, wherein the second results identify a local peak. For example, the system may run an autocorrelation function (ACF) on the original time series and determine local peaks in the ACF. This can be done multiple ways, but an example way is to check if a point is greater in value than its surrounding n (sometimes five) neighbors. The ACF is a mathematical tool used in time-series analysis to quantify the relationship between a time-series data sequence and its lagged versions. It helps to identify and measure the correlation between a datapoint at a certain time and datapoints at previous time steps. The ACF is a fundamental concept in understanding patterns and dependencies within a time-series dataset.

The system may generate aggregate results by combining the first results and the second results. For example, results from the periodogram Fisher G-test and the ACF are pooled by the system, duplicate values are removed by the system, and any values that happen to be greater than half the size of the dataset are removed by the system. For example, these values may have been found in error and cannot be considered as a seasonal period value. The remaining set of seasonal periods are listed together as the “candidate set” of seasonal periods, meaning the system will test out all these period values to determine which one fits best.

The system may generate filtered results by filtering duplicate values or values greater than a value corresponding to half of a number of datapoints in the sequence of datapoints. These values may have been found in error and cannot be considered as a seasonal period value. The remaining set of seasonal periods are listed together as the “candidate set” of seasonal periods, meaning the system will test out all these period values to determine which one fits best.

The system may determine the first statistical profile of the first dataset based on the filtered results. For example, a simple hyperparameter tuning process is run using only the candidate seasonal periods as hyperparameters (default values for everything else), and the target to minimize will be the validation score determined by evaluating the model trained on the first 85% of observations and tested on the final 15% of observations. The final selected seasonal period value is the period hyperparameter value that minimized the error on the holdout set. The user is returned the seasonal period value.

In some embodiments, the system may generate a periodogram to generate the statistical profile using a Fisher G-test and T-BATS model. In some embodiments, accurately detecting seasonality in time-series datasets is an incredibly difficult task (let alone detecting multiple simultaneous seasonal periods) but is important to many modeling tasks that require knowing the seasonality details of the data. This idea aims to determine the presence of multiple seasonality and determine multiple seasonal periods via a supervised learning approach by identifying candidate combinations and determining the best combination by fitting a T-BATS model to the user's dataset.

The system may generate a first periodogram calculated from the first dataset, wherein the first periodogram indicates candidate seasonal periods present in the first dataset. For example, the system may receive an input of a time-series dataset for which it detects multiple seasonal periods. In turn, the system may generate a periodogram.

The system may process the first periodogram using a Fisher G-test to determine a first set of results. For example, the system may run a Fisher G-test on the periodogram calculated from the dataset to determine candidate seasonal periods present in the dataset. If no values are returned, the system returns none. If one value is returned, the system returns the one value. However, if there are two or more values, the system finds all the combinations of one or more candidate seasonal period values.

The system may determine a number of values in the first set of results. For example, in response to determining that the number of values in the first set of results corresponds to one, the system may determine a seasonal period value based on a result in the first set of results.

The system may, in response to determining that the number of values in the first set of results is greater than one, determine a combination of the first set of results. For each of the identified combinations, a T-BATS model may be run by the system using the seasonal period combination as a hyperparameter. A hyperparameter tuning algorithm may also be run by the system to tune the other hyperparameters of the T-BATS algorithm, all within default ranges and for a default number of iterations.

The T-BATS (Trigonometric Seasonal Box-Cox Transformation) model is a time-series forecasting model that is designed to handle time-series data with complex seasonal patterns and multiple seasonalities. It extends the traditional BATS (Box-Cox transformation, ARMA errors, Trend, and Seasonal components) model to incorporate trigonometric functions to capture different seasonal patterns. T-BATS is particularly useful for time-series data with various seasonal cycles that cannot be easily captured by standard forecasting models. T-BATS decomposes time-series data into multiple seasonal components, each represented by trigonometric functions (sinusoidal and cosinusoidal). This allows the model to capture multiple seasonal cycles that might exist within the data.

Unlike traditional seasonal decomposition methods that are designed for simple seasonal patterns (e.g., yearly or quarterly), T-BATS can handle more complex seasonalities, such as weekly, daily, or other irregular seasonal cycles. The Box-Cox transformation helps stabilize the variance of the data, making it more suitable for modeling. The model can automatically determine the appropriate transformation parameter. T-BATS employs Autoregressive Moving Average (ARMA) errors to account for potential autocorrelation in the residuals of the model. The model includes a trend component that captures the overall direction of the time series. T-BATS is particularly useful in domains where the data exhibits multiple and complex seasonal patterns, such as retail sales with both weekly and yearly seasonality (e.g., holiday sales and weekly buying patterns). Traditional forecasting models may struggle to capture such patterns, but T-BATS' flexibility makes it well-suited for such scenarios.

The system may process the combination using a T-BATS model to determine the first statistical profile, wherein the T-BATS model uses the combination as a hyperparameter. In some embodiments, the T-BATS models may be trained on the first 80% of the dataset, and the hyperparameters will be tuned by measuring the model's performance on the first 80% of the dataset as well, using a MAPE score. The validation score may then be extracted on the final 20% of the data for each seasonal period combination. Whichever single seasonal period or combination of multiple seasonal periods gave the best validation score on the 20% holdout data will be selected and returned to the user.

In some embodiments, the system may determine a statistical profile based on determining the additive seasonality or multiplicative seasonality in the first dataset. For certain hyperparameter tuning and model selection tasks for time-series datasets, it can be important to know ahead of time whether the dataset exhibits additive seasonality or multiplicative seasonality. While conventional techniques rely on visual recognition, the system may use a set of machine learning models in a supervised way to determine which seasonal method fits models better on average. Additionally or alternatively, the system may use a seasonal decomposition model if the dataset is large in order to save time and/or resources.

The system may generate a first periodogram calculated from the first dataset, wherein the first periodogram indicates candidate seasonal periods present in the first dataset. For example, the system receives an input of a time-series dataset for which it would like to determine the presence of additive seasonality or multiplicative seasonality.

The system may process the first periodogram using a Fisher G-test to determine a first set of results, wherein the first set of results indicates whether seasonality exists in the first dataset. The system may perform a Fisher G-test that is run on the time-series dataset's periodogram to determine if significant seasonality exists in the first place. If no significant values are determined from this test, the system may exit out and return results that indicate that there was no seasonality detected in the dataset.

In response to determining that seasonality exists, the system determines whether the first dataset comprises a threshold number of datapoints. For example, if there are more than 10,000 datapoints present (or other threshold), a machine learning approach may take too much time, so a seasonal decomposition approach may be used by the system instead. For example, the system may use an open-source seasonal decomposition model that is applied, first with the additive hyperparameter and then with the multiplicative hyperparameter. Whichever approach had the lowest sum of squared residuals may then be returned by the system. In response to determining that the first dataset does comprise the threshold number of datapoints, the system may apply a seasonal decomposition model using the default hyperparameter and using the toggled parameter. The system may determine a first sum of squared residuals by assigning the toggled parameter to correspond to the additive seasonality parameter. The sum of squared residuals, often denoted as SSR or SSE, is a statistical measure that quantifies the differences between observed datapoints and the values predicted by a model. It is commonly used in regression analysis to assess the goodness of fit of a model to the actual data. In regression analysis, the goal is to create a model that best represents the relationship between independent variables (predictors) and a dependent variable (response). The sum of squared residuals measures the total squared distance between the observed datapoints and the corresponding predicted values from the regression model. The system may determine a second sum of squared residuals by assigning the toggled parameter to correspond to the multiplicative seasonality parameter. The system may determine the additive seasonality or multiplicative seasonality in the first dataset by comparing the first sum of squared residuals and the second sum of squared residuals.

In response to determining that the first dataset does not comprise a threshold number of datapoints, the system fits a default model to the first dataset using a default hyperparameter and using a toggled parameter. For example, if there was seasonality detected, the system may then determine if there are more than 10,000 datapoints present (or other threshold necessary). If not, then the machine learning model approach can be taken. The system may use a default set of statistical models that fit the given dataset using their default hyperparameters but with the additive/multiplicative seasonality type parameters toggled to all be additive.

The system may assign the toggled parameter to correspond to various parameters. For example, the system may assign the toggled parameter to correspond to an additive seasonality parameter.

The system may determine a first average validation score across all models using an expanding window strategy. The average validation score may be extracted by the system across all the models using an expanding window strategy, and this average score will be saved for the “additive” approach. The system may perform the process again, but this time with the “multiplicative” hyperparameter toggled for all the models instead of additive, and an average validation score is extracted using the same expanding window strategy.

The system may assign the toggled parameter to correspond to a multiplicative seasonality parameter. Multiplicative seasonality is a characteristic of time-series data where the seasonal pattern exhibits changes in amplitude that are proportional to the overall level of the data. In other words, the magnitude of the seasonal fluctuations increases or decreases as the data values themselves increase or decrease. In contrast to additive seasonality, where the seasonal pattern is added to the base level of the data, multiplicative seasonality involves multiplying the base level by the seasonal component. This means that as the data values increase, the seasonal fluctuations become more pronounced, and as the data values decrease, the fluctuations become less pronounced.

The system may determine a second average validation score across all models using the expanding window strategy. The system may then determine additive seasonality or multiplicative seasonality in the first dataset by comparing the first average validation score and the second average validation score. For example, the system may compare the two scores, and whichever approach has the better validation score may be returned by the system as the true presence of additive or multiplicative seasonality in the dataset. The system may then determine the first statistical profile based on determining the additive seasonality or multiplicative seasonality in the first dataset.

In some embodiments, the system may determine the first statistical profile based on determining seasonal period values. For example, accurately detecting seasonality in time-series datasets is an incredibly difficult task, but it is important to many modeling tasks that require knowing the seasonality of the data. In some embodiments, the system may determine the best value for (potentially multiple) seasonal periods present in the dataset by building out Fourier features from the time series and discovering the most important frequencies present in the dataset using feature importance from a gradient-boosted model trained on the target variable.

The system may determine a plurality of feature importance values for the first dataset. For example, the system may receive an input of the time-series dataset for which it would like to determine seasonal period values. The system may receive a target variable to predict one that varies with time. Alternatively or additionally, the system may support exogenous features if the dataset has them. Optionally, the system may use an algorithm to determine feature importance values, but a gradient-boosted decision tree model may be provided by default.

The system may determine a plurality of Fourier feature values. Fourier features, also known as Fourier basis functions or Fourier transformation, are mathematical techniques used to represent data in a different domain-specifically, the frequency domain by decomposing it into a combination of sinusoidal and cosinusoidal functions. Fourier features are used in a wide range of fields, including signal processing, image analysis, and machine learning. The Fourier transformation is particularly useful for analyzing periodic or oscillatory patterns within data. It converts a time-domain signal (or spatial domain in the case of images) into a frequency-domain representation, revealing the frequencies and their amplitudes that make up the original signal. In the context of machine learning, Fourier features can be used to transform data before feeding it into a learning algorithm. For example, in image classification tasks, Fourier transformation can be applied to images to convert pixel intensities into frequency components, which can sometimes provide a more compact and informative representation of the data. The basic idea of Fourier features involves representing data as a sum of sinusoidal and cosinusoidal functions of different frequencies. The transformation is achieved using the Fourier series or the Fourier transform, depending on whether the data is discrete (like time-series data) or continuous (like continuous signals).

The system may determine an average importance value of the plurality of feature importance values. For example, Fourier features may be built out for period values up to half the length of the dataset. if there are exogenous features present or not. If there are exogenous features, the system may loop through all the Fourier features one at a time. The system may fit the gradient-boosted model to the dataset to fit the time-series target variable using all exogenous features and this one Fourier feature.

The system may extract feature importance values of all features. The system may take the average importance value of the exogenous features and divide the Fourier feature importance value by it. If this value is greater than 1, this Fourier feature is determined to be important for prediction compared to the exogenous feature set, and the system may calculate the seasonal period value from the frequency of the Fourier feature. After looping through all Fourier features, all seasonal period values that are determined by the system to be important may be returned as results.

The system may determine a subset of the plurality of Fourier feature values, wherein the subset comprises respective Fourier feature values of the plurality of Fourier feature values in which a quotient corresponding to average importance value divided by the respective Fourier feature values is greater than one. The system may determine seasonal period values based on the subset. The system may determine the first statistical profile based on determining seasonal period values. For example, determining the seasonal period values based on the subset may comprise calculating a respective seasonal period value from a frequency of a respective Fourier feature in the subset.

Additionally or alternatively, the system may determine an exogenous feature and fit a gradient-boosted model to the first dataset to fit a time-series target variable using the exogenous feature and a Fourier feature of the plurality of Fourier feature values. A gradient-boosted model, specifically a Gradient Boosting Machine (GBM), is a powerful machine learning technique used for both regression and classification tasks. It is an ensemble learning method that combines the predictions of multiple weak models (often decision trees) to create a strong predictive model. Gradient boosting is a popular approach due to its ability to handle complex relationships in data and produce accurate predictions.

For example, the system may fit a gradient-boosted model with the plurality of Fourier feature values simultaneously. For example, if there are no exogenous features, the system may fit the gradient-boosted model with all the Fourier features simultaneously. The system may extract all feature importance values across all the Fourier features. The system may find outliers in this set by using a z-score, and the system may determine all Fourier features that had a z-score greater than two. The system may calculate the periods of all the frequencies of the chosen outlier Fourier features, and this list may be returned in the results. The system may determine feature importance values for the plurality of Fourier feature values. The system may determine an outlier of the feature importance values based on a z-score of the outlier, wherein determining the subset is based on the outlier. The z-score of an outlier is a statistical measure that quantifies how far a datapoint is from the mean of a dataset in terms of standard deviations. It is used to identify and assess the degree of “outlierness” of a datapoint within the context of the distribution of the entire dataset.

At step 508, process 500 (e.g., using one or more components described above) determines a statistical profile. For example, the system may determine a first statistical profile for the first dataset based on the statistical model. For automated model selection for time-series datasets, it is important to be able to determine whether or not the dataset contains “spiky” data (e.g., data that contains large swings, as certain time-series models cannot be fit properly to data that exhibits spikiness) or other categories and/or characteristics (e.g., seasonality). In some embodiments, the system may scan a given dataset for periods of spikiness that are independent of the specific range of the overall dataset and do not use any measure of variance of the data.

For example, the first statistical profile corresponds to a determination of a spikiness of the first dataset. “Spiky data” may describe a type of data pattern characterized by sudden and extreme fluctuations or spikes in values. These spikes are often significantly higher or lower than the surrounding datapoints and can create a visually noticeable departure from the typical or expected pattern.

At step 510, process 500 (e.g., using one or more components described above) selects, based on the first statistical profile, an untrained model from a plurality of untrained models for training. For example, the system may select, based on the first statistical profile, a first untrained model from a first plurality of untrained models for training, wherein the first plurality of untrained models comprises respective algorithms for time-series forecasting and wherein each of the first plurality of untrained models comprises default hyperparameter tuning. For example, as described above, the system may select, based on the statistical profile, a first untrained model from a first plurality of untrained models for training, wherein the first plurality of untrained models comprises respective algorithms for time-series forecasting and wherein each of the first plurality of untrained models comprises default hyperparameter tuning. For example, default hyperparameter tuning may refer to the process of using the default parameter values provided by a machine learning algorithm or library without explicitly adjusting them. Hyperparameters are parameters that are set before the training process begins and control aspects of the training process itself rather than being learned from the data, like model parameters.

At step 512, process 500 (e.g., using one or more components described above) tunes a hyperparameter of the untrained model using the dataset. For example, the system may, based on selecting the first untrained model, tune a first hyperparameter of the first untrained model using the first dataset. For example, the system may, based on selecting the first untrained model, tune a first hyperparameter of the first untrained model using the first dataset. To make an untrained model useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for minimizing development time in artificial intelligence models by automating model selection based on dataset fittings of time-series data prior to hyperparameter optimization.
2. The method of any one of the preceding embodiments, further comprising: receiving a first dataset; generating a first feature input based on the first dataset; inputting the first feature input into a first plurality of statistical routines to determine a first plurality of respective outputs, wherein the first plurality of statistical routines performs a respective first statistical analysis of the first feature input, wherein each of the first plurality of statistical routines is based on a first respective algorithm; determining a first aggregate statistical profile for the first dataset; selecting, based on the first aggregate statistical profile, a first untrained model from a first plurality of untrained models for training, wherein the first plurality of untrained models comprises respective algorithms for time-series forecasting, and wherein each of the first plurality of statistical routines comprises default hyperparameter tuning; and based on selecting the first untrained model, tuning a first hyperparameter of the first untrained model using the first dataset.
3. The method of any one of the preceding embodiments, wherein determining the first plurality of respective outputs further comprises: determining a first time period for a first model of the first plurality of statistical routines; determining a first statistical variation for the first model over the first time period; and determining a respective output, of the first plurality of respective outputs, for the first model based on the first statistical variation.
4. The method of any one of the preceding embodiments, wherein selecting, based on the first aggregate statistical profile, the first untrained model from the first plurality of untrained models for training further comprises: comparing a first respective output of the first plurality of respective outputs to a threshold value; and determining a difference between the first respective output and the threshold value, wherein selecting the first untrained model is based on the difference.
5. The method of any one of the preceding embodiments, wherein selecting, based on the first aggregate statistical profile, the first untrained model from the first plurality of untrained models for training further comprises: filtering the first plurality of untrained models based on the first aggregate statistical profile to generate a filtered subset of the first plurality of untrained models; and selecting the first untrained model from the filtered subset.
6. The method of any one of the preceding embodiments, wherein selecting, based on the first aggregate statistical profile, the first untrained model from the first plurality of untrained models for training further comprises: filtering the first plurality of untrained models based on an age of the first dataset to generate a filtered subset of the first plurality of untrained models; and selecting the first untrained model from the filtered subset.
7. The method of any one of the preceding embodiments, wherein selecting, based on the first aggregate statistical profile, the first untrained model from the first plurality of untrained models for training further comprises: filtering the first plurality of untrained models based on a reliability of the first dataset to generate a filtered subset of the first plurality of untrained models; and selecting the first untrained model from the filtered subset.
8. The method of any one of the preceding embodiments, wherein selecting, based on the first aggregate statistical profile, the first untrained model from the first plurality of untrained models for training further comprises: ranking the first plurality of untrained models based on the first aggregate statistical profile to generate a ranked order of the first plurality of untrained models; and selecting the first untrained model based on the ranked order.
9. The method of any one of the preceding embodiments, wherein selecting, based on the first aggregate statistical profile, the first untrained model from the first plurality of untrained models for training further comprises: determining respective training time predictions for each of the first plurality of untrained models based on the first aggregate statistical profile; and selecting the first untrained model based on the respective training time predictions.
10. The method of any one of the preceding embodiments, wherein selecting, based on the first aggregate statistical profile, the first untrained model from the first plurality of untrained models for training further comprises: determining respective performance predictions for each of the first plurality of untrained models based on the first aggregate statistical profile; and selecting the first untrained model based on the respective performance predictions.
11. The method of any one of the preceding embodiments, wherein selecting, based on the first aggregate statistical profile, the first untrained model from the first plurality of untrained models for training further comprises: determining respective predictions for a number of hyperparameters requiring training for each of the first plurality of untrained models based on the first aggregate statistical profile; and selecting the first untrained model based on the respective predictions for the number of hyperparameters requiring training.
12. The method of any one of the preceding embodiments, wherein selecting, based on the first aggregate statistical profile, the first untrained model from the first plurality of untrained models for training further comprises: determining respective sample size requirements for training for each of the first plurality of untrained models based on the first aggregate statistical profile; and selecting the first untrained model based on the respective sample size requirements for training.
13. The method of any one of the preceding embodiments, wherein selecting, based on the first aggregate statistical profile, the first untrained model from the first plurality of untrained models for training further comprises: determining respective processing power requirements for training for each of the first plurality of untrained models based on the first aggregate statistical profile; and selecting the first untrained model based on the respective processing power requirements for training.
14. The method of any one of the preceding embodiments, wherein inputting the first plurality of respective outputs into the profiling model to determine the first aggregate statistical profile for the first dataset further comprises: generating a profile matrix for the first dataset; and populating values of the profile matrix based on a comparison of the first plurality of respective outputs and respective model requirements for the first plurality of untrained models.
15. The method of any one of the preceding embodiments, further comprising: receiving a first dataset, wherein the first dataset comprises time-series data having a sequence of datapoints at equally spaced points in time over a dataset time range; selecting a statistical profile type to identify in the first dataset; retrieving a statistical model corresponding to the statistical profile type; determining a first statistical profile for the first dataset based on the statistical model; selecting, based on the first statistical profile, a first untrained model from a first plurality of untrained models for training, wherein the first plurality of untrained models comprises respective algorithms for time-series forecasting, and wherein each of the first plurality of untrained models comprises default hyperparameter tuning; and based on selecting the first untrained model, tuning a first hyperparameter of the first untrained model using the first dataset.
16. The method of any one of the preceding embodiments, further comprising: determining a threshold percent change for the first dataset; determining a first time range that is less than the dataset time range; determining a first subset of the sequence of datapoints, wherein the first subset begins at a first datapoint in the sequence of datapoints and includes datapoints within the first time range from the first datapoint; determining a first maximum datapoint value of the first subset and a first minimum datapoint value of the first subset; determining a first difference between the first maximum datapoint value and the first minimum datapoint value; determining a second time range that is less than the dataset time range; determining a second subset of the sequence of datapoints, wherein the second subset begins at a second datapoint in the sequence of datapoints and includes datapoints within the second time range from the second datapoint, and wherein the second datapoint is immediately after the first datapoint in the sequence of datapoints; determining a second maximum datapoint value of the second subset and a second minimum datapoint value of the second subset; determining a second difference between the second maximum datapoint value and the second minimum datapoint value; determining a percent change between the first subset and the second subset based on an absolute value of the first difference and the second difference; comparing the percent change to the threshold percent change; and determining the first statistical profile of the first dataset based on comparing the percent change to the threshold percent change.
17. The method of any one of the preceding embodiments, wherein the first statistical profile corresponds to a determination of a spikiness of the first dataset.
18. The method of any one of the preceding embodiments, wherein the threshold percent change comprises a number between zero and one.
19. The method of any one of the preceding embodiments, further comprising: generating a first periodogram by decomposing the sequence of datapoints using a Fourier transform; processing the first periodogram using a Fisher G-test to determine first results, wherein the first results comprise a seasonal period value; processing the sequence of datapoints using an autocorrelation function to determine second results, wherein the second results identify a local peak; generating aggregate results by combining the first results and the second results; generating filtered results by filtering duplicate values or values greater than a value corresponding to half of a number of datapoints in the sequence of datapoints; and determining the first statistical profile of the first dataset based on the filtered results.
20. The method of any one of the preceding embodiments, further comprising: generating a first periodogram calculated from the first dataset, wherein the first periodogram indicates candidate seasonal periods present in the first dataset; processing the first periodogram using a Fisher G-test to determine a first set of results; determining a number of values in the first set of results; in response to determining that the number of values in the first set of results is greater than one, determining a combination of the first set of results; and processing the combination using a T-BATS model to determine the first statistical profile, wherein the T-BATS model uses the combination as a hyperparameter.
21. The method of any one of the preceding embodiments, further comprising: in response to determining that the number of values in the first set of results corresponds to one, determining a seasonal period value based on a result in the first set of results.
22. The method of any one of the preceding embodiments, further comprising: generating a first periodogram calculated from the first dataset, wherein the first periodogram indicates candidate seasonal periods present in the first dataset; processing the first periodogram using a Fisher G-test to determine a first set of results, wherein the first set of results indicates whether seasonality exists in the first dataset; in response to determining that seasonality exists, determining whether the first dataset comprises a threshold number of datapoints; in response to determining that the first dataset does not comprise a threshold number of datapoints, fitting a default model to the first dataset using a default hyperparameter and using a toggled parameter; assigning the toggled parameter to correspond to an additive seasonality parameter; determining a first average validation score across all models using an expanding window strategy; assigning the toggled parameter to correspond to a multiplicative seasonality parameter; determining a second average validation score across all models using the expanding window strategy; determining additive seasonality or multiplicative seasonality in the first dataset by comparing the first average validation score and the second average validation score; and determining the first statistical profile based on determining the additive seasonality or multiplicative seasonality in the first dataset.
23. The method of any one of the preceding embodiments, further comprising: in response to determining that the first dataset does comprise the threshold number of datapoints, applying a seasonal decomposition model using the default hyperparameter and using the toggled parameter; determining a first sum of squared residuals by assigning the toggled parameter to correspond to the additive seasonality parameter; determining a second sum of squared residuals by assigning the toggled parameter to correspond to the multiplicative seasonality parameter; and determining the additive seasonality or multiplicative seasonality in the first dataset by comparing the first sum of squared residuals and the second sum of squared residuals.
24. The method of any one of the preceding embodiments, further comprising: determining a plurality of feature importance values for the first dataset; determining a plurality of Fourier feature values; determining an average importance value of the plurality of feature importance values; determining a subset of the plurality of Fourier feature values, wherein the subset comprises respective Fourier feature values of the plurality of Fourier feature values in which a quotient corresponding to average importance value divided by the respective Fourier feature values is greater than one; determining seasonal period values based on the subset; and determining the first statistical profile based on determining seasonal period values.
25. The method of any one of the preceding embodiments, wherein determining the seasonal period values based on the subset comprises calculating a respective seasonal period value from a frequency of a respective Fourier feature in the subset.
26. The method of any one of the preceding embodiments, further comprising: determining an exogenous feature; and fitting a gradient-boosted model to the first dataset to fit a time-series target variable using the exogenous feature and a Fourier feature of the plurality of Fourier feature values.
27. The method of any one of the preceding embodiments, further comprising: fitting a gradient-boosted model with the plurality of Fourier feature values simultaneously; determining feature importance values for the plurality of Fourier feature values; and determining an outlier of the feature importance values based on a z-score of the outlier, wherein determining the subset is based on the outlier.
28. One or more non-transitory, computer-readable mediums storing instructions that, when executed by a data processing apparatus, cause the data processing apparatus to perform operations comprising those of any of embodiments 1-27.
29. A system comprising one or more processors; and memory storing instructions that, when executed by the processors, cause the processors to effectuate operations comprising those of any of embodiments 1-27.
30. A system comprising means for performing any of embodiments 1-27.

What is claimed is:

1. A system for automating model selection based on dataset fittings of time-series data that comprises non-standardized variance prior to hyperparameter optimization, the system comprising:
one or more processors; and
one or more non-transitory, computer-readable mediums comprising instructions that, when executed by the one or more processors, cause operations comprising:
receiving a first dataset, wherein the first dataset comprises time-series data having a sequence of datapoints at equally spaced points in time over a dataset time range;
selecting seasonality as a statistical profile type to identify in the first dataset;
retrieving a statistical model corresponding to the seasonality;
determining a first statistical profile for the first dataset based on the statistical model by:
generating a first periodogram for the first dataset using a Fourier transform; and
processing the first periodogram using a Fisher G-test;
selecting, based on the first statistical profile, a first untrained model from a first plurality of untrained models for training, wherein the first plurality of untrained models comprises respective algorithms for time-series forecasting, and wherein each of the first plurality of untrained models comprises default hyperparameter tuning; and
based on selecting the first untrained model, tuning a first hyperparameter of the first untrained model using the first dataset.

2. A method for automating model selection based on dataset fittings of time-series data that comprises non-standardized variance prior to hyperparameter optimization, the method comprising:
receiving a first dataset, wherein the first dataset comprises time-series data having a sequence of datapoints at equally spaced points in time over a dataset time range;
selecting a statistical profile type to identify in the first dataset;
retrieving a statistical model corresponding to the statistical profile type;
determining a first statistical profile for the first dataset based on the statistical model;
selecting, based on the first statistical profile, a first untrained model from a first plurality of untrained models for training, wherein the first plurality of untrained models comprises respective algorithms for time-series forecasting, and wherein each of the first plurality of untrained models comprises default hyperparameter tuning; and
based on selecting the first untrained model, tuning a first hyperparameter of the first untrained model using the first dataset.

3. The method of claim 2, further comprising:
determining a threshold percent change for the first dataset;
determining a first time range that is less than the dataset time range;
determining a first subset of the sequence of datapoints, wherein the first subset begins at a first datapoint in the sequence of datapoints and includes datapoints within the first time range from the first datapoint;
determining a first maximum datapoint value of the first subset and a first minimum datapoint value of the first subset;
determining a first difference between the first maximum datapoint value and the first minimum datapoint value;
determining a second time range that is less than the dataset time range;
determining a second subset of the sequence of datapoints, wherein the second subset begins at a second datapoint in the sequence of datapoints and includes datapoints within the second time range from the second datapoint, and wherein the second datapoint is immediately after the first datapoint in the sequence of datapoints;
determining a second maximum datapoint value of the second subset and a second minimum datapoint value of the second subset;
determining a second difference between the second maximum datapoint value and the second minimum datapoint value;
determining a percent change between the first subset and the second subset based on an absolute value of the first difference and the second difference;
comparing the percent change to the threshold percent change; and
determining the first statistical profile of the first dataset based on comparing the percent change to the threshold percent change.

4. The method of claim 3, wherein the first statistical profile corresponds to a determination of a spikiness of the first dataset.

5. The method of claim 3, wherein the threshold percent change comprises a number between zero and one.

6. The method of claim 2, further comprising:
generating a first periodogram by decomposing the sequence of datapoints using a Fourier transform;
processing the first periodogram using a Fisher G-test to determine first results, wherein the first results comprise a seasonal period value;
processing the sequence of datapoints using an autocorrelation function to determine second results, wherein the second results identify a local peak;
generating aggregate results by combining the first results and the second results;
generating filtered results by filtering duplicate values or values greater than a value corresponding to half of a number of datapoints in the sequence of datapoints; and
determining the first statistical profile of the first dataset based on the filtered results.

7. The method of claim 2, further comprising:
generating a first periodogram calculated from the first dataset, wherein the first periodogram indicates candidate seasonal periods present in the first dataset;
processing the first periodogram using a Fisher G-test to determine a first set of results;
determining a number of values in the first set of results;
in response to determining that the number of values in the first set of results is greater than one, determining a combination of the first set of results; and
processing the combination using a T-BATS model to determine the first statistical profile, wherein the T-BATS model uses the combination as a hyperparameter.

8. The method of claim 7, further comprising:
in response to determining that the number of values in the first set of results corresponds to one, determining a seasonal period value based on a result in the first set of results.

9. The method of claim 2, further comprising:
generating a first periodogram calculated from the first dataset, wherein the first periodogram indicates candidate seasonal periods present in the first dataset;
processing the first periodogram using a Fisher G-test to determine a first set of results, wherein the first set of results indicates whether seasonality exists in the first dataset;
in response to determining that seasonality exists, determining whether the first dataset comprises a threshold number of datapoints;
in response to determining that the first dataset does not comprise a threshold number of datapoints, fitting a default model to the first dataset using a default hyperparameter and using a toggled parameter;
assigning the toggled parameter to correspond to an additive seasonality parameter;
determining a first average validation score across all models using an expanding window strategy;
assigning the toggled parameter to correspond to a multiplicative seasonality parameter;
determining a second average validation score across all models using the expanding window strategy;
determining additive seasonality or multiplicative seasonality in the first dataset by comparing the first average validation score and the second average validation score; and
determining the first statistical profile based on determining the additive seasonality or multiplicative seasonality in the first dataset.

10. The method of claim 9, further comprising:
in response to determining that the first dataset does comprise the threshold number of datapoints, applying a seasonal decomposition model using the default hyperparameter and using the toggled parameter;
determining a first sum of squared residuals by assigning the toggled parameter to correspond to the additive seasonality parameter;
determining a second sum of squared residuals by assigning the toggled parameter to correspond to the multiplicative seasonality parameter; and
determining the additive seasonality or multiplicative seasonality in the first dataset by comparing the first sum of squared residuals and the second sum of squared residuals.

11. The method of claim 2, further comprising:
determining a plurality of feature importance values for the first dataset;
determining a plurality of Fourier feature values;
determining an average importance value of the plurality of feature importance values;
determining a subset of the plurality of Fourier feature values, wherein the subset comprises respective Fourier feature values of the plurality of Fourier feature values in which a quotient corresponding to average importance value divided by the respective Fourier feature values is greater than one;
determining seasonal period values based on the subset; and
determining the first statistical profile based on determining seasonal period values.

12. The method of claim 11, wherein determining the seasonal period values based on the subset comprises calculating a respective seasonal period value from a frequency of a respective Fourier feature in the subset.

13. The method of claim 11, further comprising:
determining an exogenous feature; and
fitting a gradient-boosted model to the first dataset to fit a time-series target variable using the exogenous feature and a Fourier feature of the plurality of Fourier feature values.

14. The method of claim 11, further comprising:
fitting a gradient-boosted model with the plurality of Fourier feature values simultaneously;
determining feature importance values for the plurality of Fourier feature values; and
determining an outlier of the feature importance values based on a z-score of the outlier, wherein determining the subset is based on the outlier.

15. A one or more non-transitory, computer-readable mediums comprising instructions that, when executed by one or more processors, cause operations comprising:
receiving a first dataset, wherein the first dataset comprises time-series data having a sequence of datapoints at equally spaced points in time over a dataset time range;
selecting a statistical profile type to identify in the first dataset;
retrieving a statistical model corresponding to the statistical profile type;
determining a first statistical profile for the first dataset based on the statistical model;
selecting, based on the first statistical profile, a first untrained model from a first plurality of untrained models for training, wherein the first plurality of untrained models comprises respective algorithms for time-series forecasting, and wherein each of the first plurality of untrained models comprises default hyperparameter tuning; and
based on selecting the first untrained model, tuning a first hyperparameter of the first untrained model using the first dataset.

16. The one or more non-transitory, computer-readable mediums of claim 15, wherein the instructions further cause operations comprising:
determining a threshold percent change for the first dataset;
determining a first time range that is less than the dataset time range;
determining a first subset of the sequence of datapoints, wherein the first subset begins at a first datapoint in the sequence of datapoints and includes datapoints within the first time range from the first datapoint;
determining a first maximum datapoint value of the first subset and a first minimum datapoint value of the first subset;
determining a first difference between the first maximum datapoint value and the first minimum datapoint value;
determining a second time range that is less than the dataset time range;
determining a second subset of the sequence of datapoints, wherein the second subset begins at a second datapoint in the sequence of datapoints and includes datapoints within the second time range from the second datapoint, and wherein the second datapoint is immediately after the first datapoint in the sequence of datapoints;
determining a second maximum datapoint value of the second subset and a second minimum datapoint value of the second subset;
determining a second difference between the second maximum datapoint value and the second minimum datapoint value;
determining a percent change between the first subset and the second subset based on an absolute value of the first difference and the second difference;
comparing the percent change to the threshold percent change; and
determining the first statistical profile of the first dataset based on comparing the percent change to the threshold percent change.

17. The one or more non-transitory, computer-readable mediums of claim 16, wherein the first statistical profile corresponds to a determination of a spikiness of the first dataset.

18. The one or more non-transitory, computer-readable mediums of claim 16, wherein the threshold percent change comprises a number between zero and one.

19. The one or more non-transitory, computer-readable mediums of claim 15, wherein the instructions further cause operations comprising:
generating a first periodogram by decomposing the sequence of datapoints using a Fourier transform;
processing the first periodogram using a Fisher G-test to determine first results, wherein the first results comprise a seasonal period value;
processing the sequence of datapoints using an autocorrelation function to determine second results, wherein the second results identify a local peak;
generating aggregate results by combining the first results and the second results;
generating filtered results by filtering duplicate values or values greater than a value corresponding to half of a number of datapoints in the sequence of datapoints; and
determining the first statistical profile of the first dataset based on the filtered results.

20. The one or more non-transitory, computer-readable mediums of claim 15, wherein the instructions further cause operations comprising:
generating a first periodogram calculated from the first dataset, wherein the first periodogram indicates candidate seasonal periods present in the first dataset;
processing the first periodogram using a Fisher G-test to determine a first set of results;
determining a number of values in the first set of results;
in response to determining that the number of values in the first set of results is greater than one, determining a combination of the first set of results; and
processing the combination using a T-BATS model to determine the first statistical profile, wherein the T-BATS model uses the combination as a hyperparameter.
